(19) United States
(12) Patent Application Publication
(10) Pub. No.: US 2015/0366403 A1
(43) Pub. Date: Dec. 24, 2015

(54) Bar-B-Que-Buddy

(71) Applicant: Sue Blumenthal, Long Grove, IL (US)

(72) Inventor: Sue Blumenthal, Long Grove, IL (US)

(21) Appl. No.: 14/311,325

(22) Filed: Jun. 22, 2014

(51) Int. Cl. A47J 37/07

(52) U.S. Cl. CPC A47J 37/0786

(57) ABSTRACT

The present invention represents a multi-purpose barbeque grilling tool with multiple benefits and applications. The current state-of-the-art offers a one-dimensional solution to controlling grill temperature. The present invention provides a multi-dimensional solution to the problem of controlling outdoor grill temperature resulting in an enhanced cooking experience.

The present invention is used on outdoor barbeque grills to facilitate the opening of hinged grill covers at multiple height openings. This allows greater control of grill temperature enhancing the user's cooking experience. In addition, immediate adjustment of grill cover opening assists in dampening “flame flare-ups” caused by the dripping of excess fat from the meat. The invention generally comprises a longitudinal arm having perpendicular protrusions secured along its length to control grill cover height, and integrated cooking utensils built into the design of the longitudinal arm of the invention. The cover of the grill is supported by any one of the protrusions allowing its user to select the desired height and subsequent temperature level.

The lid of a barbecue grill is supported by a longitudinal arm having slightly angled notches along its leading edge supporting by the grill cover when it is raised or lowered. The longitudinal arm has a lower end that bears directly on the main stove and integrated tools aiding the user in the outdoor cooking experience.

### CROSS-REFERENCE TO RELATED APPLICATIONS

Provisional Patent Application No. 61/838,240, filed Jun. 22, 2013.

### FEDERALLY SPONSORED RESEARCH

Not Applicable

### NAMES OF PARTIES TO A JOINT RESEARCH AGREEMENT

Not Applicable

### SEQUENCE LISTING OR PROGRAM

Not Applicable.

### BACKGROUND OF THE INVENTION

The present invention relates to a low cost, multi-function device enhancing the cooking experience of users of all types of outdoor grills, particularly today's popular natural gas and propane based barbeque grills. A barbecue grill is a device that is used to cook food by applying heat directly from below, typically using either as or charcoal as its fuel source. Barbecuing is a popular tradition throughout much of the world, and a grill's design, heating source, and size can vary dramatically depending upon application. The present invention seeks to improve the grilling experience of the average residential user owning a grill comprised of a flat grilling surface typically ranging in size of one or two square feet up to seven or eight square feet.

The primary function of the present invention relates to regulation, fixed support, and flexible alteration of grill cover opening on conventional outdoor grills. Modern day grills generally are comprised of a sturdy support base, a main stove section, and a cover secured to the stove section via a hinge assembly. Sturdy construction of the modern grill is achieved through the use of heavyweight cast metals, such as aluminum resulting in grill covers of considerable mass. In its most common configuration, most if not all gas grills generally have only two positions for the hinged hood of the grill, either open or closed. Such rigidness in the design and flexibility of existing gas grills, coupled with the substantial weight of the grill cover, simply does not allow its user to adequately regulate cooking temperature, control grill flare-up, or provide proper grill ventilation necessary for optimum cooking. The present invention is a removable, stand-a-lone device allowing the hood of the grill to be rapidly adjusted to multiple hood opening positions providing its user enhanced heating control leading to improved cooking results. The present invention is of a universal design allowing effective use on grills of all shapes and sizes, and without requiring modifications to any existing grill cover(s).

Improved cooking results from outdoor grills are accomplished by varying the positioning of the grill cover above the main stove section. While the hood is completely closed, very high heating levels are obtained in very short periods of time. As the hood is opened, reduced levels of heating are obtained along with the added benefit of introducing outside air for limiting internal fires caused by fatty run-off from cooked foods. Different cooking preferences require different heating levels, a primary benefit afforded by the proposed invention.

Recognition of the problem of uncontrolled heating levels in grills was first addressed in the art by rather crude means. Sticks, rocks, or anything readily available to the user was often placed between the grill cover and main stove bodies in order to temporarily prop open grill covers. Manufacturer's even attempted their own solutions with various forms of hinge support designs, albeit with limited success most likely due to the massive size of many grill covers and the cyclic metal fatigue failures associated with the repeated opening and closing of the covers themselves. While accomplishing the immediate task of allowing the stoves to “breathe,” the makeshift props were clumsy, difficult to manage, and unreliable at best. The proposed invention solves the problem of reliability, sturdiness, and consistency of opening a grill cover at various heights, all in an effort to control the grill heating environment necessary for various forms of outdoor cooking.

An alternative function of the proposed invention is its ability to consolidate multiple tools into its “all-in-one” design. Currently, the user of a grill is forced to multi-task during the course of the entire grilling experience. The user of the grill effectively undergoes a four step process during each grilling experience, ranging from (i) grill preparation, (ii) grill management, (iii) grill cleanup, and (iv) grill closure/storage. Efficiencies gained during any of these steps represent technology advancements over the current state-of-the-art. In particular, the proposed invention provides efficiencies within the second step of the process, “grill management.” This particular function requires the user to carefully monitor grill temperature, adjust grill temperature as necessary, manage grill ventilation to acceptable levels, monitor food status, turn food over as necessary for even grilling, monitor cook time, monitor food status, evaluate and repeat until complete. The proposed invention is perfectly suited to assist its user in effectively managing this multi-step process. Embedded within the proposed invention's unique design is a tubular slot originating on its upper surface containing a removable thermometer. This thermometer provides its user with the added convenience of having this critical cooking tool readily available to further monitor and control heating levels, thus further improving the cooking experience. As an integral aspect of the proposed invention, the user is freed from having to rely on the famously inaccurate grill thermometer (assuming the manufacturer has even provided one), spared the inconvenience of having to locate a standalone thermometer in advance of grill preparation, freed from having to remember to individually bring a separate thermometer with him/her to the outdoor grilling location, and in the event the user forgets to bring the desired thermometer, minimizes the safety issues of leaving the grill unattended while stepping away momentarily to locate a thermometer.

An alternative function of the proposed invention relates to another of its all-in-one features which serves to aid in grill management. This includes the existence of a removable fork neatly tucked into the body of the proposed invention. Rather than the user having to recall bringing separate grilling utensils, the proposed invention maintains the tool as an integral part of its efficient design. Similar to the integrated thermometer, the integrated fixed or easily detachable cooking fork provides its users with certain efficiencies within the second step of the multi-step “grill management” process discussed above. Embedded within the proposed invention's unique design is a cavity along the longitudinal surface of the proposed invention. The integrated fork provides its user with the added convenience of having a specific cooking utensil readily available to assist in the cooking process. As an integral aspect of the proposed invention, the user is freed from needing multiple hands necessary to bring all tools to the grilling site, spared the inconvenience of having to locate a separate cooking utensil in advance of grill preparation, freed from having to remember to bring a separate cooking utensil with him/her to the outdoor grilling location, and in the event the user forgets to bring the desired cooking utensil, minimizes the safety issues of leaving the grill unattended while stepping away momentarily to locate such a utensil.

### SUMMARY OF THE INVENTION

The present invention is an improved barbeque cooking tool providing multiple benefits and applications without requiring permanent modification of, or attachment to, existing grills. A primary objective of the present invention is in controlling grill temperature by providing its user with the flexibility to adjust the opening of a barbeque grill cover to multiple fixed positions.

Another primary function of the invention is its ability to provide structural support to the grill cover while the cover is in a fixed, open position. This provides the grill operator with an alternative means of operating an otherwise massive and often times clumsy grill cover. A complementary objective of the present invention is its ease of operation in adjusting between various grill cover openings, and in its ease of removal when the barbecue grill cover is raised by its user.

Another function of the present invention is its natural ability to extend the life of everyday grills. The present invention permits grill cover support that not only provides grill cover pivoting for adjustability, but simultaneously relieves the grill cover hinge(s) of having to bear the full weight of the grill cover during adjustments, adding additional cyclic life to the mechanical hinges of the grill cover.

Another function of the present invention is its ability to consolidate multiple tools into its “all-in-one” design. Embedded within the proposed invention's unique design is a cylindrical slot originating on its upper surface containing a removable thermometer providing its user with the added convenience of having immediate access to a tool critical to monitoring and controlling grill temperature. Also embedded within the proposed invention's unique design is a cavity providing integrated access to a grilling utensil providing its user with the added convenience of having a specific cooking utensil readily available to assist in the outdoor cooking process.

Additional objectives, advantages and novel features of proposed invention are set forth in particularity in the following detailed description and appended claims.

### DRAWINGS

The features of the invention believed to be novel will be set forth with particularity in the appended claims of the forthcoming non-provisional patent application. The invention itself is best understood by reference to the following brief descriptions in conjunction with the accompanying drawings and will be supplemented with additional drawings during the submission of the non-provisional patent application.

FIG. 1 is a perspective drawing displaying the fully assembled invention. This drawing provides a view of each of the elements of the invention as assembled including the body of the invention, working elements of the invention, thermometer and utensil.

FIG. 2 is an alternative embodiment of the invention displaying alternative means for utensil attachment.

### DRAWINGS

### Reference Numerals

1 Longitudinal Body of Invention
2 Handle
3 Hinge Pin
4 Base Lock
5 Height Adjustment
6 Thermometer
7 Thermometer Cylindrical Housing
8 Utensil
9 Utensil Handle Attachment
10 Utensil Cavity Housing
11 Utensil Pivot
12 Utensil in Closed Position
13 Utensil in Open Position

### DETAILED DESCRIPTION OF THE INVENTION

### Description

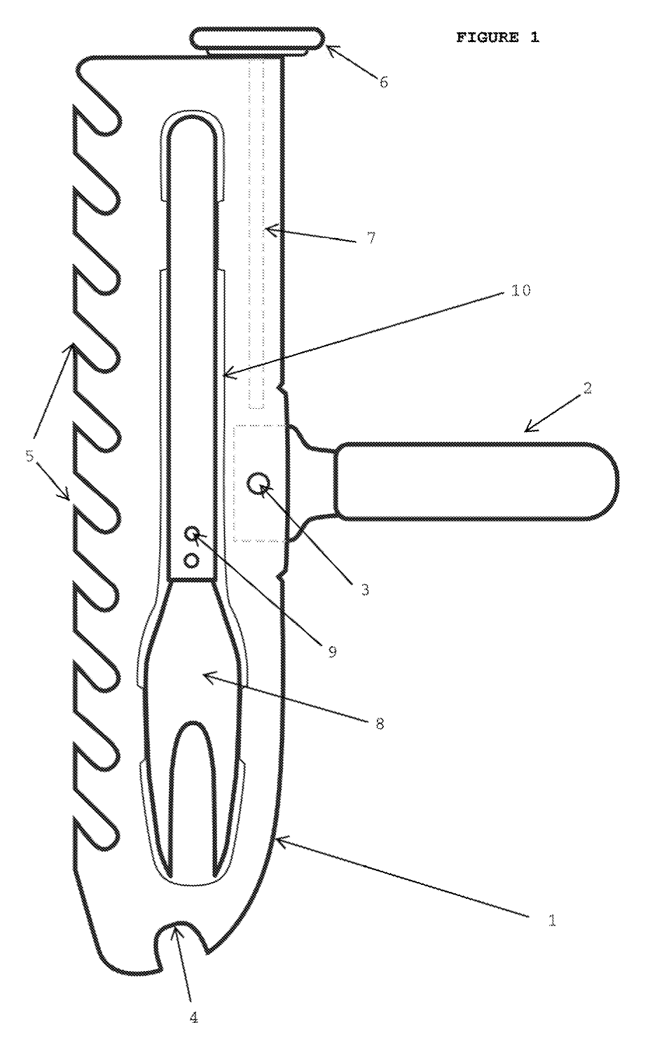

FIG. 1 represents a perspective view of the preferred embodiment of the invention. The basic embodiment of invention is comprised of only two elements including a notched Longitudinal Body (1), and the Handle (2). Integral to the design of the first embodiment of the invention is the Base Lock (4) situated along the base of the Longitudinal Body (1), and multiple Height Adjustments (5), also referred to as notches, positioned at fixed increments along the entire leading edge of the Longitudinal Body. The design and placement of the notches and Base Lock may vary slightly along the Longitudinal Body in order to accommodate a limited number of grill designs on the market today. The Handle (2) rotates around a fixed Hinge Pin (3), the Hinge Pin itself permanently affixed to the Longitudinal Body at its midpoint and along its aft edge.

The first embodiment of the invention includes all of the components of the preferred embodiment referenced above, but is expanded to include a Thermometer (6), and a Utensil (8). The utensil displayed in the alternative embodiment is a fork, but the invention can be expanded to include multiple other utensils depending upon required cooking application. In order to functionally accommodate the Thermometer (6), the invention provides for an internal Thermometer Cylindrical Housing (7) beginning on the top surface of the Longitudinal Body, and running approximately halfway down the length of the Longitudinal Body. Additionally, the alternative embodiment provides for an internal cavity, referred to as the Utensil Cavity Housing (10), providing for internal storage of the Utensil inside the Longitudinal Body (1). Various forms of Utensil Handle Attachments (9) are envisioned comprising pop-rivets, screws, alternative material fasteners, etc., depending upon the type of cooking application and particular utensil selected.

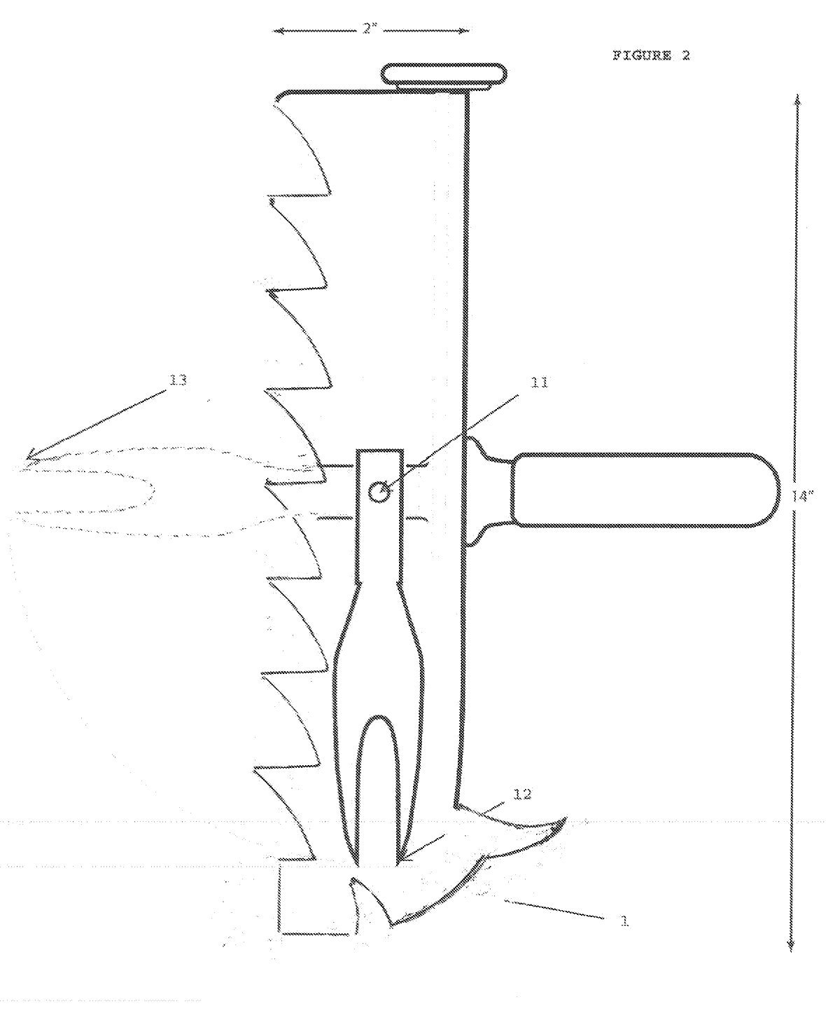

A second alternative embodiment of the invention includes all of the components of the preferred embodiment and first alternative embodiment referenced above, but alters the selection of the type of utensil to be used in the invention. FIG. 1 displays a detachable Utensil (8) of a fixed length, comprised of tongs and a handle, and connected via Utensil Handle Attachments (9). The second embodiment in FIG. 2 alters the design of the Utensil by altering the design of the Utensil (12). The second embodiment incorporates a Utensil Pivot (11) at the midpoint of the Longitudinal Body (1), providing for a Utensil in Closed Position (12), or for a Utensil in Open Position (13). While the preferred embodiment envisions a removable Utensil, the second alternative embodiment provides for a fixed Utensil. The fixed Utensil assumes a user does not necessarily requiring the simultaneous use of the grill cover opening function along with use of the Utensil. This alternative embodiment includes a fixed Utensil rotating about a fixed Utensil Pivot (11), requiring the entire invention to be portable in order to efficiently use the Utensil (8).

### Operation

With reference to the drawings FIGS. 1 and 2, the invention is used to universally open any type of barbecue grill cover, and to provide its user with greater convenience and control over the outdoor cooking experience. In a typical barbecue grill, the grill has a conventional hinged grill cover resting atop a main stove base. The grill covers generally can be propped open from any edge, except for the hinged sides which typically reside on the backward edge of the grill. The proposed invention may be temporarily attached to the grill base at any point, providing extreme flexibility in its useful degrees of freedom. Consequently, the user possesses the freedom to place the proposed invention in “out-of-the-way” locations, or to entirely remove the proposed invention if necessary.

In the preferred embodiment, the height of the opening of a barbecue grill cover and corresponding cooking temperature are controlled through the varied use of the proposed invention. Prior to its first use, the invention will be found in its compact storage state, with the Handle (2) and all attachments (if any) in their closed positions. The first step in using the invention is to open the Handle (2) by rotating the handle along its fixed. Hinge Pin (3) until the Handle locks into its open position. When open, the Handle will be perpendicularly positioned relative to the Longitudinal Body (1). Metal stops along the surface of the Longitudinal Body (1) will allow for the Handle (2) to be locked into place, thereby preventing rotational slipping of the Handle during operation.

With the Handle (2) in its operational open position, the user may now position the invention between the grill cover and the main stove section by inserting the Base Lock (4) of Longitudinal Body (1) at a point along the upper rectangular perimeter of the main stove section. With the invention firmly locked at a point on the main stove section, the height of the grill cover opening is controlled by allowing the lower edge of the grill cover to rest upon any one of the plurality of notches, or Height Adjustments (5), which are positioned at fixed increments along the leading edge of the Longitudinal Body (1). The Height Adjustments (5) are slightly angled in a downward fashion allowing the grill cover to neatly fall into the notch of each desired Height Adjustment, the mass of the cover serving to lock the grill cover into place.

To alter the grill cover opening, the user simply releases the weight bearing down on the invention by raising the grill cover slightly in order to temporarily reduce the weight of the grill cover resting on the Height Adjustment (5). Concurrently, the user can minimize the grill cover opening by allowing the grill cover to drop to a lower Height Adjustment, or maximize the grill cover opening by raising the grill cover to a higher Height Adjustment along the Longitudinal Body. In this fashion, the user can continuously control cooking temperature through constant variation of grill cover height.

The first embodiment of the proposed invention provides the user with additional tools to enhance the user's outdoor cooking experience. Although many outdoor grills may already contain a fixed thermometer, these thermometers are notoriously inaccurate and prone to failure. The internal Thermometer (6) of the proposed invention is used in a variety of applications. The Thermometer serves multiple functions and is neatly tucked into its Cylindrical Housing (7) located inside the Longitudinal Body (1) of the invention itself. First, its integrated design makes transport of the Thermometer to and from the outdoor cooking location exceedingly convenient. Second, the Thermometer is used as a secondary resource serving to validate or invalidate notoriously inaccurate grill thermometers. Third and unlike internal grill thermometers which are often hard to read, the Thermometer provides its user with an easily readable indication of cooking temperature even without removing the Thermometer from its Housing. This is because the Thermometer is conveniently positioned at the very top of the Longitudinal Body. Fourth, the Thermometer can be used to measure temperatures of objects other than outside air cooking temperatures. Because the Thermometer is removable, it can be used to measure internal food temperatures. This dual function is achieved through the Thermometer's ease of removal regardless of whether the invention is being used to prop the grill cover open or not. The user simply pulls up on the Thermometer, sliding the Thermometer out along the length of its Housing, and removing the Thermometer from the Longitudinal Body; all accomplished without the user having to leave the cooking area to obtain a separate tool. With the Thermometer removed, the user is now in a position to insert the Thermometer directly into the food (for instance, into a cross section of meat) to further ensure cooking accuracy.

In a similar fashion, the first embodiment of the proposed invention provides the user with a separate Utensil to enhance and simplify the user's outdoor cooking experience. The Utensil (8) of the proposed invention is envisioned to be used in a variety of manners. First, the Utensil is neatly tucked into a specially designed cavity (the Utensil Cavity Housing (10)) on the inside and along the length of the Longitudinal Body (1). This integrated design makes transport of the Utensil to and from the outdoor cooking location exceedingly convenient and safe since the user is not required to leave the cooking area to secure a forgotten cooking utensil. Second, the Utensil is easily removable from the Longitudinal Body simply by pulling up on the Utensil until it detaches from the press fit cavity in which it resides. Third, the removal operation can be performed while the invention is in use propping open the grill cover. In other words, the proposed invention does not have to be relieved of its function of propping the grill cover open in order to allow its user to release the Utensil. With the Utensil removed, the user is now in a position to turn over the food in the grill further ensuring cooking accuracy.

A second embodiment of the invention varies the function of the Utensil within the scope of the Utensil's intended use. While the preferred embodiment envisions a removable Utensil, a variation will provide for a fixed Utensil. The fixed Utensil envisions a user not necessarily requiring the simultaneous use of the grill cover opening function in conjunction with the use of the Utensil. This alternative embodiment includes a fixed Utensil rotating about a fixed Utensil Pivot (11), requiring the entire invention to become portable in order to efficiently use the Utensil (8).

1. An apparatus used in outdoor barbeque cooking comprising a handle attached to an elongated body, the means for controlling cooking including notches along the perimeter of one side of the elongated body.

2. The apparatus of claim 1 wherein the means for control includes a transportable, multi-function device.

3. The apparatus of claim 2 wherein one or more of the multi-functions includes an integrated, removable thermometer.

4. The apparatus of claim 2 wherein one or more of the multi functions includes an integrated, cooking utensil.

5. The apparatus of claim 4 wherein the cooking utensil is a fork.

6. An apparatus used in outdoor barbeque cooking comprising a movable handle attached to an elongated body, the means for controlling cooking including insertion of the apparatus between the grill base and grill hood with grill hood opening varied by selection of individual notches along the perimeter of one side of the elongated body.

7. The apparatus of claim 6 wherein the means for control includes a transportable, multi-function device.

8. The apparatus of claim 7 wherein one or more of the multi-functions includes an integrated, removable thermometer.

9. The apparatus of claim 7 wherein one or more of the multi-functions includes an integrated, cooking utensil.

10. The apparatus of claim 9 wherein the cooking utensil is a fork.

11. An apparatus used to control the temperature of a barbeque grill comprising a movable handle attached to an elongated body, the means for controlling temperature including insertion of the apparatus between the grill base and grill hood with grill temperature varied by placement of the grill hood within one of the individual notches existing along the perimeter of one side of the elongated body.

12. The apparatus of claim 11 wherein the means for control includes a transportable, multi-function device.

13. The apparatus of claim 12 wherein one or more of the multi-functions includes an integrated, removable thermometer.

14. The apparatus of claim 12 wherein one or more of the multi-functions includes an integrated, cooking utensil.

15. The apparatus of claim 14 wherein the cooking utensil is a fork.
